(19) United States
(12) Patent Application Publication
(10) Pub. No.: US 2018/0293560 A1
(43) Pub. Date: Oct. 11, 2018

(54) SYSTEMS AND METHODS FOR A CENTRALIZED PAYMENT MANAGEMENT SYSTEM

(71) Applicant: XO Group Inc., New York, NY (US)

(72) Inventor: Shaun Sims, Austin, TX (US)

(21) Appl. No.: 15/943,993

(22) Filed: Apr. 3, 2018

Related U.S. Application Data
(63) Continuation of application No. 14/203,845, filed on Mar. 11, 2014, now abandoned.
(60) Provisional application No. 61/784,144, filed on Mar. 14, 2013.

(51) Int. Cl. G06Q 20/10; G06Q 20/02

(52) U.S. Cl. CPC G06Q 20/10; G06Q 20/02

(57) ABSTRACT

Systems and methods for a centralized payment management system are described. The system aids in management of vendor-client relationships. In one aspect, the system receives payment entries relating to a combination of vendors and clients. The system determines from the payment entries a payment entry that includes a conflict. The system retrieves from a memory an alert message associated with the payment entry including the conflict. The system generates a display screen including the payment entry and the retrieved alert message. In some embodiments, the system determines from the payment entries a payment entry that includes a conflict by determining from the payment entries a payment entry that includes an overdue payment issue, a client issue, or vendor issue, generating an alert message for the determined payment entry based on the overdue payment issue, the client issue, or the vendor issue, and storing the alert message in the memory.

### CROSS-REFERENCE TO RELATED PATENT APPLICATIONS

This application claims the benefit of U.S. Provisional Patent Application No. 61/784,144, filed Mar. 14, 2013, which is hereby incorporated by reference in its entirety.

### BACKGROUND

Event planning in today's world is a stressful management exercise for all types of events ranging from weddings to baby showers to bar mitzvahs. One of the sources of stress for clients stems from having to manage different vendors that provide services during the event, e.g., florists, photographers, caterers, and other suitable vendors. Particularly, each vendor may have different schedules of payments and may further require different modes of payment ranging from cashier's checks to cash only. On the other hand, a source of stress for vendors may arise from concerns regarding timely payment from clients. Maintaining cash flow for vendors, particularly small business owners, is important for healthy functioning of their enterprises. Approaching conversations regarding payment can be awkward for both clients and vendors. Furthermore, there can be several conflicts generated due to miscommunication or other mishaps between clients and vendors. For example, the client may mistake a vendor's promptness in requesting payment to be a lack of trust from the vendor or even interpret it as rudeness and bad client service. Such conflicts may be especially detrimental for vendors who rely on referrals from past clients for obtaining future business. Therefore, there is a need for a payment management system having client-vendor management capabilities.

### SUMMARY

This disclosure relates generally to the field of payment management systems. More particularly, this disclosure relates to systems and methods for a centralized payment management system having client-vendor management capabilities.

The systems and methods described herein provide for a centralized payment management system between clients and vendors. The system can provide a common platform for vendors and clients to view payment information. The system may provide an administrator or third-party handling the management system with details on payment information between clients and vendors. The payment entries may include payment due dates, amount due, and other related information. The centralized payment management system may generate and provide alerts to the administrator in case of conflicts or complaints from vendors or clients. The conflicts may be generated due to missed or overdue payments, complaints or requests from clients, complaints or requests from vendors, or other suitable circumstances. The administrator may mediate or arrange for a third-party mediation between the vendor and the client to resolve the conflict.

In one aspect, the systems and methods described herein provide for a method relating to a centralized payment management system. The method includes receiving, from a network interface, payment entries relating to a combination of vendors and clients. The method further includes determining from the payment entries a payment entry that includes a conflict. The method further includes retrieving from a memory an alert message associated with the payment entry including the conflict. The method further includes generating a first display screen including the payment entry and the retrieved alert message.

In some embodiments, determining from the payment entries a payment entry that includes a conflict includes determining from the payment entries a payment entry that is associated with an alert message. In some embodiments, determining from the payment entries a payment entry that includes a conflict includes determining from the payment entries a payment entry that includes an overdue payment issue, a client issue, a vendor issue, or a suitable conflict in a vendor-client relationship, generating an alert message for the determined payment entry that includes the overdue payment issue, the client issue, the vendor issue, or the suitable conflict in the vendor-client relationship, and storing the alert message in the memory. In some embodiments, a client issue or a vendor issue is automatically generated in response to a complaint from one of a client and a vendor associated with the payment entry. In some embodiments, an overdue payment issue is generated based on a payment due date included in the payment entry. In some embodiments, a potential client issue, a potential vendor issue, a potential overdue payment, or any other suitable circumstance, is generated pre-emptively based on the client's payment history, the number of vendors waiting for payment, the proximity of payment due dates, or any other suitable payment-related data.

In some embodiments, the payment entry includes a client, a vendor, an amount due, a payment due date, or any other suitable information. In some embodiments, the method further includes generating a second display screen including additional information regarding the alert message associated with the payment entry that includes the conflict. In some embodiments, the second display screen is generated in response to a user request for reviewing the alert message.

In some embodiments, the memory stores an application programming interface (API), and the processor receives the user request for reviewing the alert message via an API function call. In some embodiments, the API function call includes a public key and a private key associated with the user used to digitally sign the API function call. The method further includes, based at least in part on the digital signature of the API function call, the identity of the user.

In another aspect, the systems and methods described herein provide for a centralized payment management system configured to execute functionality described above. It should be noted that the systems and/or methods described above may be applied to, or used in accordance with, other systems, methods and/or apparatuses.

### BRIEF DESCRIPTION OF THE DRAWINGS

The above and other objects and advantages of the systems and methods described herein will be apparent upon consideration of the following detailed description, taken in conjunction with the accompanying drawings, in which like reference characters refer to like parts throughout, and in which:

FIG. 1A is a block diagram of a centralized payment management system including a web/app server, according to an illustrative embodiment;

FIG. 1B is a block diagram of a web/app server, according to an illustrative embodiment;

FIG. 2 is a first display screen for an administrator or manager of the centralized payment management system, according to an illustrative embodiment;

FIG. 3 is a second display screen for an administrator or manager of the centralized payment management system, according to an illustrative embodiment;

FIG. 4 is a display screen for a client of the centralized payment management system, according to an illustrative embodiment;

FIG. 5 is a process flow diagram illustrating a process for client-vendor relationship management, according to an illustrative embodiment; and

FIG. 6 is a process flow diagram illustrating a process for generating an alert message, according to an illustrative embodiment; and

FIG. 7 is a process flow diagram illustrating another process for generating an alert message, according to an illustrative embodiment.

### DETAILED DESCRIPTION

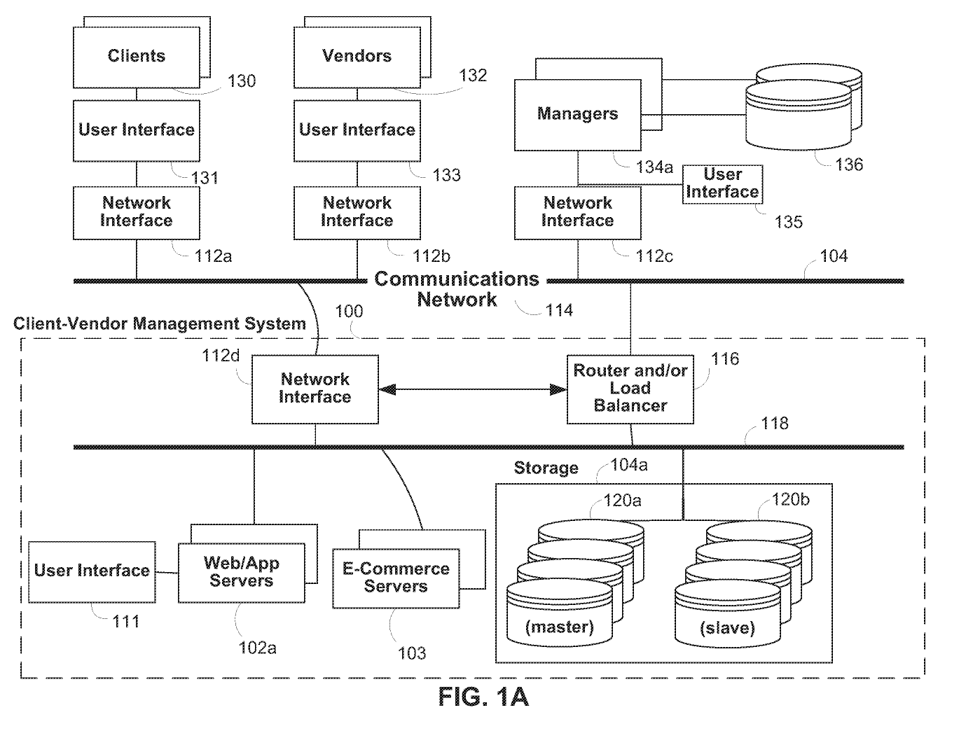

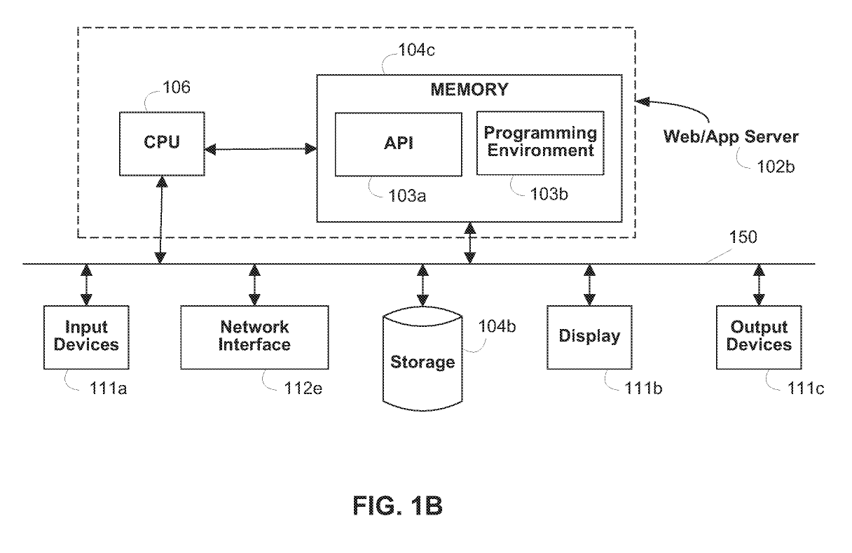

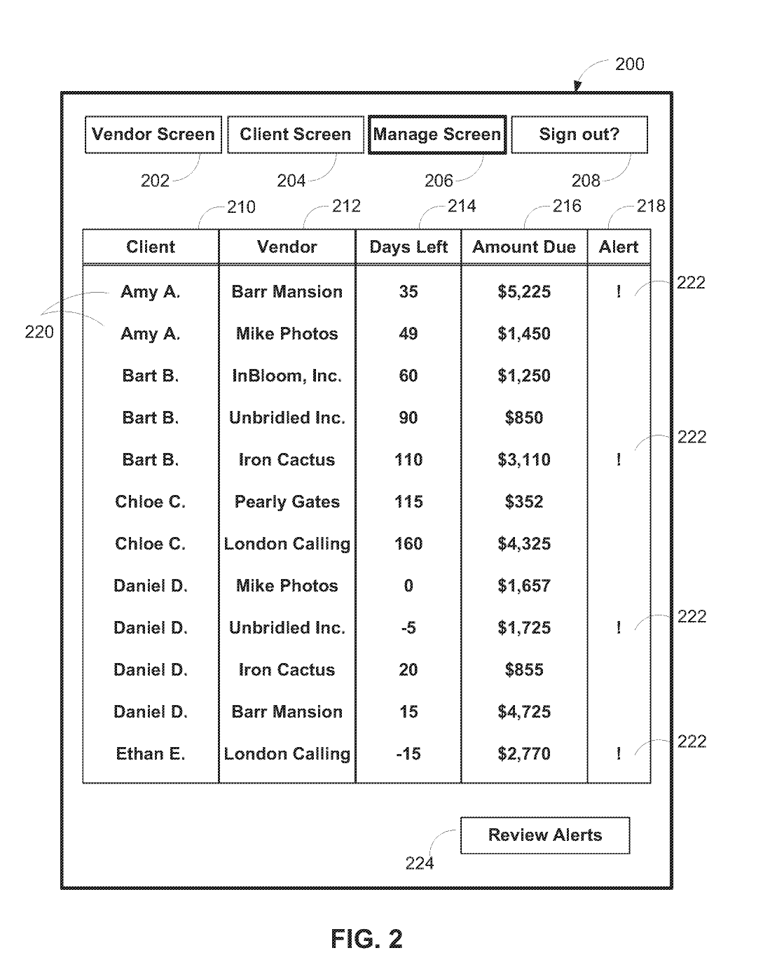

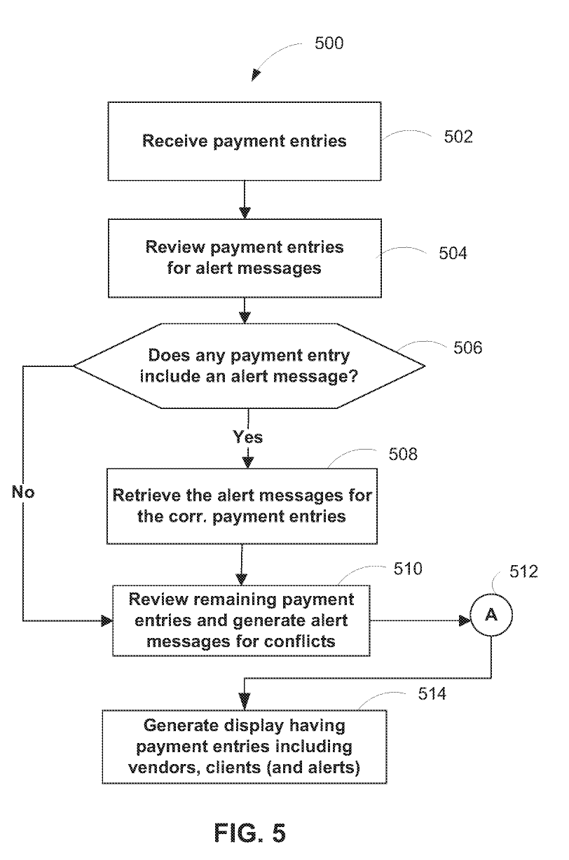

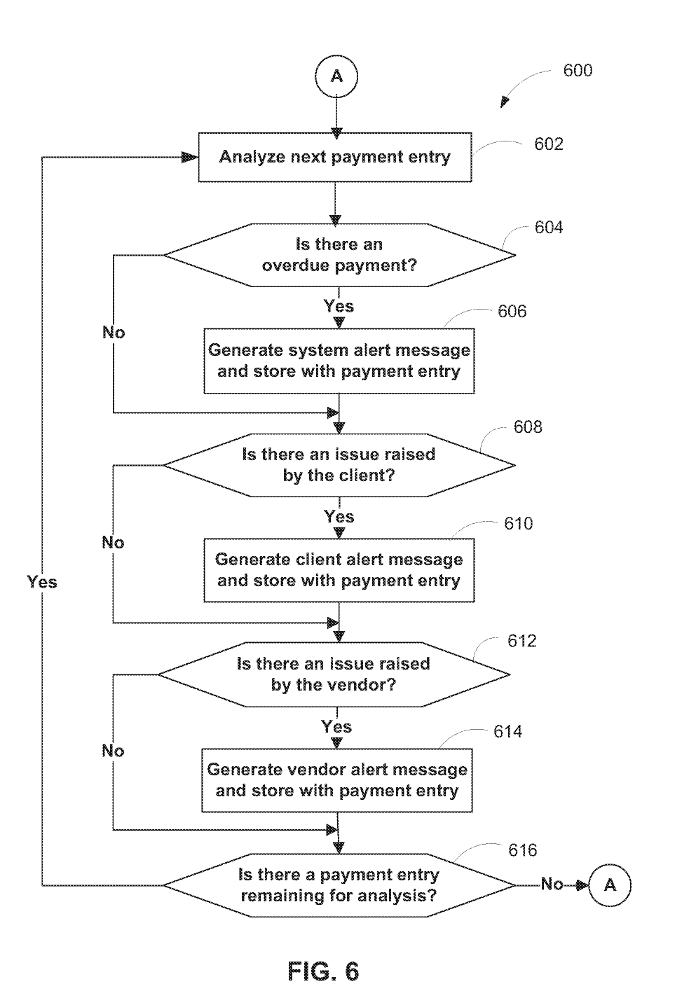

Various illustrative devices and platforms that may implement embodiments of the present centralized payment management system are described in more detail below with reference to FIGS. 1A and 1B. Display screens for illustrative embodiments are described with reference to FIGS. 2, 3, and 4. While the display screens of FIGS. 2, 3, and 4 are illustrated as full or partial-screen displays (e.g., web pages), they may generally be displayed in any suitable size or format. FIGS. 5 and 6 contain illustrative process flow diagrams for processes that may be implemented on the systems of FIGS. 1A and 1B, to generate displays (e.g., web pages), e.g., the display screens of FIGS. 2, 3, and 4.

FIG. 1A shows a block diagram of a system 100, which includes one or more Internet servers/application servers or web/app servers 102a. The system may include a vendor payment platform, a client-vendor management platform, or other suitable combination thereof. In some embodiments, system 100 may process payment information for multiple vendors and corresponding multiple clients. The web/app servers 102a (discussed further in relation to FIG. 1B) are in communication with one or more e-commerce servers 103, a storage 104a, a network interface 112d, and a user interface 111, via system network 118. The communications between these devices may be wired or wireless communications. Storage 104a may include storage devices 120a and/or storage devices 120b. Storage devices 120a and 120b may include any suitable fixed or removable storage devices, e.g., hard drives and optical drives, and include any suitable memory, e.g., random-access memory, read-only memory. This memory may be used to store any suitable information for system 100. In some embodiments, memory within storage device 136 may store computer-readable program instructions, e.g., an API, which, when executed by a processor within a computing device (not shown) at manager system 134a, may perform a particular process. In some embodiments, memory within storage device 136 may including payment entries, payment due dates, amounts due, client names, vendor names, alert messages, or any other suitable information.

Network interface 112d may include a cable modem, an integrated services digital network (ISDN) modem, a digital subscriber line (DSL) modem, a telephone modem, a wireless modem, a satellite receiver, a router, a wireless or wired modem, a cellular or satellite phone, or any other suitable equipment that allows for communication between the web/app servers 102 and a communications network 114. System network 118 and communications network 114 may be any suitable wired or wireless network, including a broadcast, cable, or satellite television network and/or the Internet. User interface 111 may include a PC, a laptop, a tablet, a WebTV box, a personal computer television (PC/TV), a PC media server, a PC media center, a PDA, a mobile telephone, or any other user computer equipment, including storage devices, user input devices, and display devices. (WebTV is a trademark owned by Microsoft Corp.). System 100 may include a router (e.g., a gateway router manufactured by Cisco Corp.) and/or a load balancer. The router may serve as a gateway between system 100 and communications network 114, while the load balancer may function to balance the storage load among the storage devices 120a and 120b within storage 104a.

System 100 may communicate with one or more clients 130, one or more vendors 132, and one or more administrators or managers 134a over communications network 114. Administrators or managers 134a may mediate or arrange for a third-party mediation between vendors and clients to resolve their conflicts. Each client 130 and vendor 132 may have their own user equipment. The user equipment may include a user interface (131, 133, 135) and/or a network interface (112a, 112b, 112c). Manager 134 may include a web/app server, or other suitable computer equipment capable of communicating with web/app server 102a of system 100. Each of the network interfaces 112a-c may include a cable modem, an integrated services digital network (ISDN) modem, a digital subscriber line (DSL) modem, a telephone modem, a wireless modem, a satellite receiver, a router, a wireless or wired modem, a cellular or satellite phone, or any other suitable equipment that allows for communication with communications network 114. Each user interface 131, 133, 135 may include a keyboard, a mouse, a PC, a laptop, a tablet, a WebTV box, a personal computer television (PC/TV), a PC media server, a PC media center, a PDA, a mobile telephone, or any other user computer equipment, including storage devices, user input devices, and display devices. For instance, manager systems 134a may have associated storage device 136. Storage device 136 may include memory. This memory may be used to store any suitable information for the manager system. In some embodiments, memory within storage device 136 may store computer-readable program instructions, e.g., an API, which, when executed by a processor within a computing device (not shown) at manager system 134a, may perform a particular process. In some embodiments, memory within storage device 136 may store one or more data structures associated with payment entries, payment due dates, amounts due, client names, vendor names, alert messages, or may store any other suitable information.

Web/app server 102a of system 100 may act as a host for a centralized payment management system, such as a client-vendor management platform. The payment information for the system may be stored in storage 104a in the form of any suitable data structure and using any suitable database programming environment, e.g., a MySQL database associated with a Linux or Apache server. In such an implementation, one set of storage devices 120a may act as the “master” MySQL database, while the other set of storage devices 120b may act as the “slave” MySQL database. Web/app server 102a may receive messages from a vendor 132 or manager 134 over communications network 114. These messages may include requests for payment entries, payment due dates, amounts due, client names, vendor names, alert messages, or any other suitable information. Each of these requests may include a request for authentication, whereby the identity of the vendor 132 is authenticated with the web/app server 102a. These requests may be processed by a processor of web/app server 102a using an API. In response to the received requests, web/app server 102a may generate and send display screens, e.g., in http or XML format, or other information associated with the system to a vendor 132.

Web/app server 102a may also receive messages from a client 130 over communications network 114. These messages may include requests for searching for payment entries, payment due dates, amounts due, client names, vendor names, alert messages, or any other suitable information. Each of these requests may include a request for authentication, whereby the identity of the client 130 is authenticated with the web/app server 102a. These requests may also be processed by a processor of web/app server 102a using the system's API. In response to the received requests, web/app server 102a may send display screens, e.g., in http format, or other information to the client 130 or vendor 132.

Web/app server 102a may also receive messages from a manager system 134a over communications network 114. These messages may include requests for searching for payment entries, payment due dates, amounts due, client names, vendor names, alert messages, or any other suitable information. Each of these requests may include a request for authentication, whereby the identity of the manager 134a is authenticated with the web/app server 102a. These requests may also be processed by a processor of web/app server 102a using the API. In response to the received requests, web/app server 102a may send display screens, e.g., in http format, or other information to the manager system 134a.

In some embodiments, the e-commerce server(s) 103 (FIG. 1A) is used to process payment requests received by the web/app server 102a. In some embodiments, e-commerce servers associated with manager(s) 134a (FIG. 1A) are configured to process payment requests received by either the system 100 (FIG. 1A) or an associated vendor. Once the payment request has been fulfilled by an e-commerce server, an indication that the payment request has been fulfilled may be transmitted between the system 100 (FIG. 1A) and an associated vendor.

FIG. 1B is a detailed block diagram of a web/app server 102b, which may be part of a payment managing system such as web/app server 102a (FIG. 1A), or a manager web/app server (not shown in FIG. 1A). Web/app server 102b includes a central processing unit (CPU) 106, and internal memory 104c. Memory 104c may include an API 103a and/or any other suitable programming environment 103b. Web/app server 102b may be in communication via network 150 with one or more input devices 111a, a network interface 112e, storage 104b, a display 111b, and one or more output devices 111c. The network interface 112e may include similar components to the network interfaces 112a-d described above in relation to FIG. 1A. Network 150 may be any suitable wired or wireless network. Storage 104b may also be similar to the storage 104a described above in relation to FIG. 1A. Display 111b may include any suitable display device, e.g., a LCD or plasma display. Input devices 111a may include a keyboard, a mouse, a remote control, or any other suitable device, while output devices 111c may include external memory or other peripheral devices that may be operable when connected to web/app server 102b via network 150.

The API may be programming language-dependent or language-independent. For example, requests via an API function call to a web/app server may be made in a particular language or format (e.g., http, XML), while responses to requests may be made in the same or a different language or format, e.g., Representational State Transfer—REST (with Extensible Mark up Language—XML) or Javascript Object Notation—JSON. In some embodiments, the administrator or manager web/app server may send requests via the API. Requests may be made in any suitable format, e.g., http, and may include requests for payment entries, payment due dates, amounts due, client names, vendor names, alert messages, or any other suitable information.

In some embodiments, the APIs are a set of “allowable” http request messages and a suitably defined set of responses. The responses may be sent in any suitable language, e.g., REST with XML or JSON. Programming references for these languages are readily available, and those skilled in the art will appreciate their availability. In some embodiments, the API allows for a number of requests from an administrator or manager. For instance, an administrator or manager web/app server may be able to search for payment entries, payment due dates, amounts due, client names, vendor names, alert messages, or any other suitable information.

In some embodiments, each request made via the API must be authenticated. An API request may also be referred to as an API function call. This authentication may be performed in any suitable manner, e.g., using a client-server public-private key system, e.g., by computing a digital signature using the HMAC-SHA1 signature method. For instance, requests made by the administrator or manager system may be authenticated by computing a digital signature using the HMAC-SHA1 signature method. Those skilled in the art will appreciate that the system may digitally sign an API request using a secret private key that only these systems and the respective API web/app server know.

To carry out such authentication, each system's API request may include fields such as api_key (a public key provided to the system that allows the API to know their identity), api_sig (e.g., a HMAC-SHA1 signature of the request that is generated by the system client using their private key), nonce (a unique random ID generated by the system to identify their request), date (the date and/or time when the request is made). In some embodiments, access to the system API may be restricted such that an administrator or manager system will only receive a public key and a private key string if the administrator or manager has permission to make requests to the system API. As with most public-private key systems, the private key string is used only to digitally sign the API request and is not included in the API request. On the other hand, the public key is included in each API request so that the system can determine, based at least in part on the digital signature of the API request, that the administrator or manager system's private key generated the API request.

Next, we turn to illustrative display screens generated by a centralized payment management system, such as system 100 (FIG. 1A). In some embodiments, these display screens may be web pages generated by the web/app server 104a (FIG. 1A) or 104b (FIG. 1B) of the system 100 (FIG. 1A) and may be transmitted to a vendor 132 (FIG. 1A), a client 130 (FIG. 1A), or a manager 134a (FIG. 1A) over the communications network 114 (FIG. 1A), allowing these entities to interact with the system 100 (FIG. 1A).

FIG. 2 is an illustrative display screen 200 for the centralized payment management system that may be generated and transmitted, e.g., over communications network 114 (FIG. 1A), to an administrator or manager. Such a display screen may be generated by system 100 (FIG. 1A), and may be generated and transmitted, e.g., over communications network 114 (FIG. 1A), to an administrator or manager after they login to access the system. Display screen 200 may include images and/or text and/or video and/or a plurality of hyperlinks to other display screens that may be generated and transmitted, e.g., over communications network 114 (FIG. 1A), to an administrator or manager. Display screen 200 includes a vendor screen option 202, a client screen option 204, a manage screen option 206, and a sign out option 208. Vendor screen option 202 may redirect the user to a login page for a vendor-side view of the system 100. Client screen option 204 may redirect the user to a login page for a client-side view of the system 100. Manage screen option 206 is highlighted to indicate that the user is viewing the administrator-side view of the system 100.

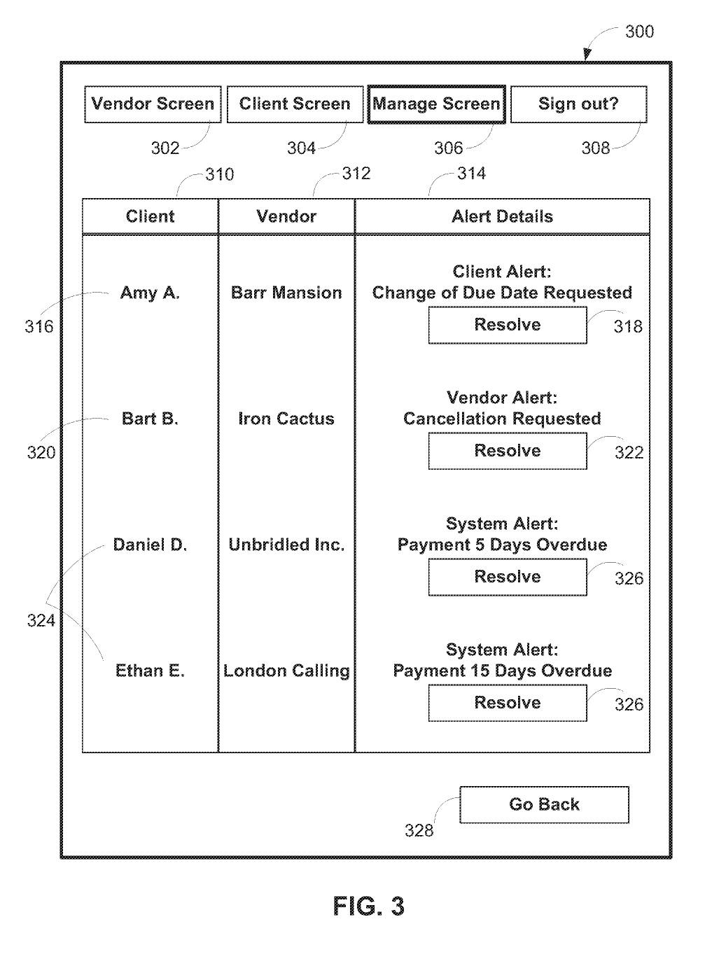

Display screen 200 further includes columns for client information 210, vendor information 212, days left for payment due 214, amount due 216, and alerts 218. For example, entries 220 indicate that client “Amy A.” owes vendors “Barr Mansion” and “Mike Photos” payments as indicated. Furthermore, alert indicators 222 are displayed to inform the administrator regarding possible conflict issues between the client and vendor for the respective entry. For example, client “Amy A.” and vendor “Barr Mansion” may have a conflict issue as indicated. In another example, client “Daniel D.” and vendor “Unbridled Inc.” may have a conflict issue as indicated. In this case the likely issue is an overdue payment since the days left indicator is 5 days overdue. The administrator may select one of alert indicators 222 or review alerts option 224 to retrieve further information regarding the conflict issues. The administrator may then be presented with display screen 300 of FIG. 3.

FIG. 3 is an illustrative display screen 300 for the centralized payment management system that may be generated and transmitted, e.g., over communications network 114 (FIG. 1A), to an administrator or manager. Such a display screen may be generated by system 100 (FIG. 1A), and may be generated and transmitted, e.g., over communications network 114 (FIG. 1A), to an administrator or manager after they select one of alert indicators 222 or review alerts option 224 to retrieve further information regarding the conflict issues. Display screen 200 may include images and/or text and/or video and/or a plurality of hyperlinks to other display screens that may be generated and transmitted, e.g., over communications network 114 (FIG. 1A), to an administrator or manager. Display screen 300 includes a vendor screen option 302, a client screen option 304, a manage screen option 306, and a sign out option 308. Vendor screen option 302 may redirect the user to a login page for a vendor-side view of the system 100. Client screen option 304 may redirect the user to a login page for a client-side view of the system 100. Manage screen option 306 is highlighted to indicate that the user is viewing the administrator-side view of the system 100.

Display screen 300 further includes columns for client information 310, vendor information 312, and alert details 314. For example, entries 324 indicate that clients “Daniel D.” and “Ethan E.” owe vendors “Unbridled Inc.” and “London Calling,” respectively, payments that are overdue. The alert details for these entries inform the administrator that the payments are 5 and 15 days overdue respectively. In this case, the system may automatically generate a system alert message if the payment entry continues to remain in the system past the due date. However, there may be multiple reasons for the overdue payment, such as incorrect credit card information from the client or lack of authorization from the vendor to deposit funds. Resolve options 326 may provide a further troubleshooting menu to help manage the relationship between the client and the vendor. The administrator may utilize this information to bring the conflict to an end in a professional and courteous manner. Additionally, the administrator may mediate or arrange for a third-party mediation between the vendor and the client to resolve the conflict.

In another example, entry 316 indicates client “Amy A.” and vendor “Barr Mansion” have a client alert message, which is different from an overdue payment. In this case, the client has entered information into the system 100 to inform the administrator that they would like to request a change in due date. The administrator may utilize resolve option 318 to contact the vendor to obtain approval for the due date, to request further information from the client, or any other steps suitable to bring the conflict to an end in a professional and courteous manner. Additionally, the administrator may mediate or arrange for a third-party mediation between the vendor and the client to resolve the conflict.

In yet another example, entry 320 indicates client “Bart B.” and vendor “Iron Cactus” have a vendor alert message, which is also different from an overdue payment. In this case, the vendor has entered information into the system 100 to inform the administrator that they would like to request a cancellation of the client order. The administrator may utilize resolve option 322 to contact the client to obtain approval for the cancellation, to request further information from the vendor, or any other steps suitable to bring the conflict to an end in a professional and courteous manner. Additionally, the administrator may mediate or arrange for a third-party mediation between the vendor and the client to resolve the conflict. The administrator may select Go Back option 328 to return to the previous screen. The administrator may then be presented with display screen 200 of FIG. 2.

In yet another example, display screen 300 may include pre-emptive alerts based on predictive algorithms that process data including total number of vendors a client has to pay, relative proximities of due dates, number of payers in the system, days until the event, historical trends of industry payment behavior, and proprietary data the system collects and aggregates over time from past users. For example, system 100 may analyze wedding vendor payment data and determine that, based on brides with similar data profiles as a given bride, there is a 45% probability of a late or overdue payment. The system may generate a pre-emptive system alert for an overdue payment if the estimate is above a certain threshold. For example, system 100 may inform the administrator of a possible overdue payment via a system alert if the threshold is 40% (which is lower than the estimated 45% chance of a late payment).

System 100 may allow the administrator to offer insurance for such transactions to the vendor, thereby allowing the vendor to maintain their cash flow through the insurance payment. System 100 may allow the administrator to automatically extend credit (directly or through a third-party) to the client based on the user's credit or payment history. Alternatively, system 100 may allow the administrator (or vendor) to offer discount pricing to the client in exchange for payments made in advance of the due date, thereby helping the vendor's cash flow. The administrator may also offer or receive an offer to buy the client contract from the vendor to pursue payments from the clients directly. The administrator may buy the client contract in exchange for a discount on the total payments due, thereby also helping the vendor's cash flow.

In some embodiments, system 100 receives vendor-client contracts for one or more of the payment entries. System 100 may host the contracts (e.g., redacted versions with the permissions of the parties) as examples for future clients or vendors to use in their future contracts. Additionally, system 100 may analyze the contracts to discover commonalities across them within certain categories, e.g., wedding vendors, baby shower vendors, or any other suitable category. For example, system 100 may use a natural language parsing system to analyze the language in wedding vendor contracts to determine frequently used language and limitations. System 100 may offer a combined framework or template uniquely created for the particular category, based on the discovered commonalities, to vendors or clients for use in their future contracts.

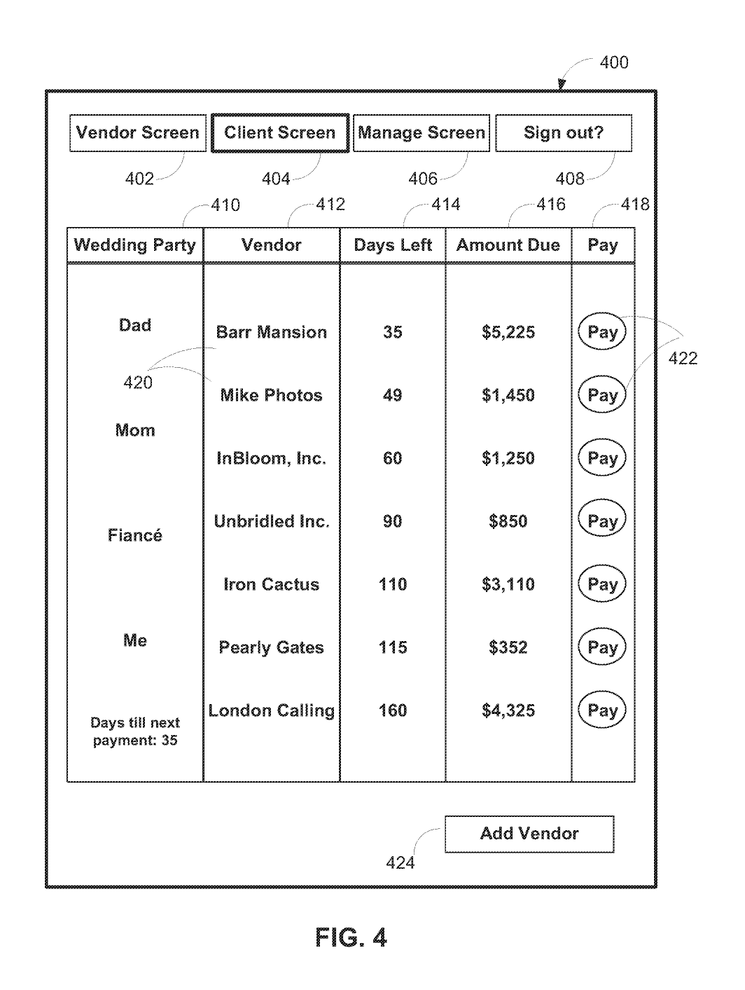

FIG. 4 is an illustrative display screen 400 for the centralized payment management system that may be generated and transmitted, e.g., over communications network 114 (FIG. 1A), to a client. Display 400 screen may be generated by system 100 (FIG. 1A), and may be generated and transmitted, e.g., over communications network 114 (FIG. 1A), to a client after they login to access the system. Display screen 400 may include images and/or text and/or video and/or a plurality of hyperlinks to other display screens that may be generated and transmitted, e.g., over communications network 114 (FIG. 1A), to a client. Display screen 400 includes a vendor screen option 402, a client screen option 404, a manage screen option 406, and a sign out option 408. Vendor screen option 402 may redirect the user to a login page for a vendor-side view of the system 100. Client screen option 404 may redirect the user to a login page for a client-side view of the system 100. Manage screen option 406 is highlighted to indicate that the user is viewing the administrator-side view of the system 100.

Display screen 400 further includes columns for wedding part information 410, vendor information 412, days left for payment due 414, amount due 416, and pay information 418. Display screen 400 may allow the client, e.g., a bride (“Me”), to easily manage all her vendor payments in one place. She may add additional vendors via option 424. For example, entries 420 indicate that vendors “Barr Mansion” and “Mike Photos” are due payments as indicated. The client may select options 422 to enter payment information, such as credit card numbers, electronic checks, proof of cash payment, or other suitable payment information. While receiving payment information from the client, system 100 may offer recommendations regarding mode of payment based on the client's and/or vendor's payment history. For example, if the client's payment history shows a significantly high number of late payments when sent by check, system 100 may recommend the client enter credit card information instead. Additionally, system 100 may use geographical information such as the client's IP address, the client device's GPS data and/or cell-tower triangulation, and other suitable geographic information, to determine the client's location to include in its consideration when making recommendations regarding mode of payment to ensure timely delivery. This may allow the system 100 to process payments to the vendors in a prompt and timely manner. Alternatively, the client may enter a conflict issue, which may be addressed by the administrator in relation to FIGS. 2 and 3 above.

Additionally, the bride may grant access to other members of the wedding party to help her manage the vendor payments. For example, the bride may send invitations to her “Dad,” “Mom,” and “Fiancé” to access payment information relating to one or more vendors. This may allow the wedding party to stay informed on the vendors and their respective payment amounts and schedules. This may also save the bride the hassle of acting as an intermediary that relays payment information between a vendor and members in her wedding party. In some embodiments, the wedding party members may add a vendor, make a payment, or enter a conflict issue directly to vendors via display screen 400, without need for the bride to manage the vendor payment issues herself. In some embodiments, system 100 shows a subset of the payment information to wedding party members. The information may be sanitized based on permission settings entered by the bride. For example, the bride may invite her fiancé's parents to access the system but may set permissions so that they may not view the payment amounts due to the vendors. In another example, the bride may invite her parents to access the system but may set permissions so that they may not view payment information for any vendors being paid for by her fiancé's parents.

In some embodiments, a display screen similar to display screen 400 may be generated and transmitted to a vendor with appropriate modifications. For example, the vendor display screen may include options to send reminders to their clients regarding upcoming payments or any other suitable issues that need their clients' attention. System 100 may cloak the payment reminders such that they look like they are coming from the centralized payment management system, and not the individual vendors. This may allow a vendor to send payment reminders to a client without risking the client being agitated or perceiving the vendor's behavior as bothersome, thereby helping preserve the vendor-client relationship.

FIG. 5 is a process flow diagram illustrating a process 500 for client-vendor relationship management, according to an illustrative embodiment. While this embodiment refers to a centralized payment management system, the process described below is applicable to any suitable system. Process 500 begins when CPU 106 (FIG. 1B) of system 100 (FIG. 1A) receives payment entries (502). The payment entries may include payment due dates, amount due, and other related information. CPU 106 (FIG. 1B) of system 100 (FIG. 1A) then reviews the payment entries for alert messages as described with respect to FIG. 3 above (504). If there are any payment entries that include an alert message (506), CPU 106 (FIG. 1B) of system 100 (FIG. 1A) retrieves the alert messages for the corresponding payment entries from memory (508). If there are no such payment entries (506), CPU 106 (FIG. 1B) of system 100 (FIG. 1A) reviews the remaining payment entries (510). CPU 106 (FIG. 1B) of system 100 (FIG. 1A) generates alert messages for any conflicts discovered in the remaining payment entries (512). The details for this process are described with respect to FIG. 6 below. Finally, CPU 106 (FIG. 1B) of system 100 (FIG. 1A) generates a display having the payment entries and associated vendors, clients, and alerts (if any) similar to display screen 200 of FIG. 2 (514).

FIG. 6 is a process flow diagram illustrating a process 600 for generating an alert message, according to an illustrative embodiment of step 512 of FIG. 5. While this embodiment refers to a centralized payment management system, the process described below is applicable to any suitable system. Process 600 begins when CPU 106 (FIG. 1B) of system 100 (FIG. 1A) analyzes a payment entry of the remaining payment entries from step 510 of FIG. 5 (602). CPU 106 (FIG. 1B) of system 100 (FIG. 1A) determines if there an overdue payment issue relating to the payment entry (604). For example, if the payment is past its due date, CPU 106 (FIG. 1B) of system 100 (FIG. 1A) may generate a system alert message and store it with the payment entry (606). Otherwise, CPU 106 (FIG. 1B) of system 100 (FIG. 1A) skips to the next step.

Next, CPU 106 (FIG. 1B) of system 100 (FIG. 1A) determines if there is an issue raised by the client relating to the payment entry (608). For example, if the client has requested a change in payment due date, CPU 106 (FIG. 1B) of system 100 (FIG. 1A) may generate a client alert message and store it with the payment entry (610). Otherwise, CPU 106 (FIG. 1B) of system 100 (FIG. 1A) skips to the next step. Next, CPU 106 (FIG. 1B) of system 100 (FIG. 1A) determines if there is an issue raised by the vendor relating to the payment entry (612). For example, if the vendor has requested an order cancellation, CPU 106 (FIG. 1B) of system 100 (FIG. 1A) may generate a vendor alert message and store it with the payment entry (614). Otherwise, CPU 106 (FIG. 1B) of system 100 (FIG. 1A) skips to the next step. Subsequently, CPU 106 (FIG. 1B) of system 100 (FIG. 1A) determines if any payment entries remain that are yet to be analyzed (616). If so, CPU 106 (FIG. 1B) of system 100 (FIG. 1A) analyzes the next payment entry (602) as described above. Otherwise, CPU 106 (FIG. 1B) of system 100 (FIG. 1A) returns to step 512 of FIG. 5.

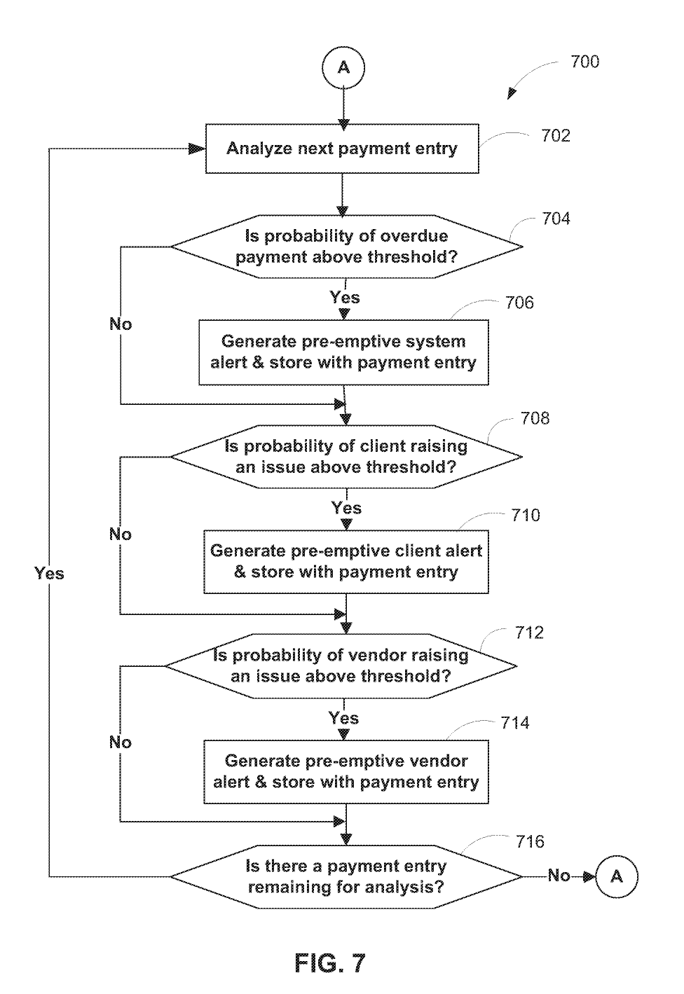

FIG. 7 is a process flow diagram illustrating a process 700 for generating an alert message, according to an illustrative embodiment of step 512 of FIG. 5. While this embodiment refers to a centralized payment management system, the process described below is applicable to any suitable system. Process 700 begins when CPU 106 (FIG. 1B) of system 100 (FIG. 1A) analyzes a payment entry of the remaining payment entries from step 510 of FIG. 5 (702). CPU 106 (FIG. 1B) of system 100 (FIG. 1A) determines a probability of an overdue payment relating to the payment entry and compares it to a threshold probability (704). In addition to the payment entry, CPU 106 (FIG. 1B) of system 100 (FIG. 1A) may analyze data including total number of vendors a client has to pay, relative proximities of due dates, number of payers in the system, days until the event, historical trends of industry payment behavior, and proprietary data the system collects and aggregates over time from past users. For example, CPU 106 (FIG. 1B) of system 100 (FIG. 1A) may determine that a 45% probability of a late or overdue payment, which is above the threshold probability of 40%. CPU 106 (FIG. 1B) of system 100 (FIG. 1A) may generate a pre-emptive system alert for a possible overdue payment and store the alert with the payment entry (706). Otherwise, CPU 106 (FIG. 1B) of system 100 (FIG. 1A) skips to the next step.

Next, CPU 106 (FIG. 1B) of system 100 (FIG. 1A) determines a probability of an issue being raised by the client relating to the payment entry (708). For example, CPU 106 (FIG. 1B) of system 100 (FIG. 1A) may determine based on the client's past history that there is a 75% probability of the client requesting a change in payment due date, which is higher than the threshold probability of 50%. CPU 106 (FIG. 1B) of system 100 (FIG. 1A) may generate a pre-emptive client alert message for a possible due date change and store it with the payment entry (710). Otherwise, CPU 106 (FIG. 1B) of system 100 (FIG. 1A) skips to the next step. Next, CPU 106 (FIG. 1B) of system 100 (FIG. 1A) determines if a probability of an issue being raised by the vendor relating to the payment entry (712). For example, CPU 106 (FIG. 1B) of system 100 (FIG. 1A) may determine based on the vendor's past history that there is a 40% chance of the vendor requesting cancellation of the client's order, which is higher than the threshold probability of 30%. CPU 106 (FIG. 1B) of system 100 (FIG. 1A) may generate a pre-emptive vendor alert message for a possible order cancellation and store it with the payment entry (714). Otherwise, CPU 106 (FIG. 1B) of system 100 (FIG. 1A) skips to the next step. Subsequently, CPU 106 (FIG. 1B) of system 100 (FIG. 1A) determines if any payment entries remain that are yet to be analyzed (716). If so, CPU 106 (FIG. 1B) of system 100 (FIG. 1A) analyzes the next payment entry (702) as described above. Otherwise, CPU 106 (FIG. 1B) of system 100 (FIG. 1A) returns to step 512 of FIG. 5.

Generally, the methods described herein may be executed on a conventional data processing platform such as an IBM PC-compatible computer running the Windows operating systems, a SUN workstation running a UNIX operating system or another equivalent personal computer, server, or workstation. Alternatively, the system may include a dedicated processing system that includes an API programming environment.

The methods described herein may also be realized as a software component operating on a conventional data processing system such as a UNIX workstation. In such an embodiment, the methods may be implemented as a computer program written in any of several languages well-known to those of ordinary skill in the art, such as (but not limited to) C, C++, FORTRAN, Java, MySQL, Perl, Python, Apache or BASIC. The methods may also be executed on commonly available clusters of processors, such as Western Scientific Linux clusters.

The methods disclosed herein may be performed in either hardware, software, or any combination thereof, as those terms are currently known in the art. In particular, the present method may be carried out by software, firmware, or microcode operating on a computer or computers of any type. Additionally, software embodying the processes described herein may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Accordingly, the systems and methods described herein are not limited to any particular platform, unless specifically stated otherwise in the present disclosure.

The foregoing is merely illustrative of the principles of the systems and methods described herein, and various modifications can be made by those skilled in the art without departing from the scope and spirit of the systems and methods described herein. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. The above described embodiments are presented for purposes of illustration and not of limitation, and the systems and methods described herein are limited only by the claims which follow.

1-20. (canceled)

21. A method for a centralized payment management system to preemptively alert users of overdue payments, comprising:
generating, using a processor, a graphical user interface for an administrator-side of the centralized payment management system;
receiving, from a network interface, a plurality of payment entries relating to at least one vendor and at least one client;
retrieving a client data profile for the at least one client, wherein the client data profile is an aggregation of past behavior of the at least one client;
retrieving a historical trend of industry payment behavior for client data profiles matching the client data profile;
determining a likelihood of an overdue payment based on the historical trend of industry payment behavior for the client data profiles matching the client data profile;
comparing the likelihood to a threshold likelihood;
in response to determining the likelihood exceeds the threshold likelihood, determining, using the processor, from the plurality of payment entries a payment entry that is associated with the at least one client includes a conflict;
retrieving, from a memory, an alert message associated with the payment entry; and
generating in the graphical user interface, using the processor, a first display screen including the payment entry and the retrieved alert message.

22. The method of claim 21, wherein determining from the plurality of payment entries that the payment entry that is associated with the at least one client includes the conflict comprises determining from the plurality of payment entries that the payment entry that is associated with the at least one client is associated with an alert message.

23. The method of claim 21, wherein determining from the plurality of payment entries that the payment entry that is associated with the at least one client includes the conflict comprises storing the alert message in the memory.

24. The method of claim 23, wherein one of a client issue and a vendor issue is automatically generated in response to a complaint from one of a client and a vendor associated with the payment entry that is associated with the at least one client.

25. The method of claim 23, wherein an overdue payment issue is automatically generated based on a payment due date included in the payment entry that is associated with the at least one client.

26. The method of claim 21, wherein the payment entry that is associated with the at least one client includes at least one of a client, a vendor, an amount due, and a payment due date.

27. The method of claim 21, further comprising generating, using the processor, a second display screen including additional information regarding the alert message associated with the payment entry that is associated with the at least one client includes the conflict.

28. The method of claim 27, wherein the second display screen is generated in response to a user request for reviewing the alert message.

29. The method of claim 28, wherein the memory stores an application programming interface (API), and the processor receives the user request for reviewing the alert message via an API function call.

30. The method of claim 29, wherein the API function call includes a public key, and a private key associated with the user used to digitally sign the API function call, further comprising determining, based at least in part on the digital signature of the API function call, the identity of the user.

31. A centralized payment management system that preemptively alerts users of overdue payments, comprising:
a memory;
a network interface; and
a processor configured to:
generate a graphical user interface for an administrator-side of the centralized payment management system;
receive, from the network interface, a plurality of payment entries relating to at least one vendor and at least one client;
retrieve a client data profile for the at least one client, wherein the client data profile is an aggregation of past behavior of the at least one client;
retrieve a historical trend of industry payment behavior for client data profiles matching the client data profile;
determine a likelihood of an overdue payment based on the historical trend of industry payment behavior for the client data profiles matching the client data profile;
compare the likelihood to a threshold likelihood;
in response to determining the likelihood exceeds the threshold likelihood, determine form the plurality of payment entries a payment entry that is associated with the at least one client includes a conflict;
retrieve, from the memory, an alert message associated with the payment entry; and
generate in the graphical user interface a first display screen including the payment entry and the retrieved alert message.

32. The system of claim 31, wherein the processor configured to determine from the plurality of payment entries that the payment entry that is associated with the at least one client includes the conflict is further configured to determine from the plurality of payment entries that the payment entry that is associated with the at least one client is associated with an alert message.

33. The system of claim 31, wherein the processor configured to determine from the plurality of payment entries that the payment entry that is associated with the at least one client includes the conflict is further configured to store the alert message in the memory.

34. The system of claim 33, wherein one of a client issue and a vendor issue is automatically generated in response to a complaint from one of a client and a vendor associated with the payment entry that is associated with the at least one client.

35. The system of claim 33, wherein an overdue payment issue is automatically generated based on a payment due date included in the payment entry that is associated with the at least one client.

36. The system of claim 31, wherein each payment entry that is associated with the at least one client includes at least one of a client, a vendor, an amount due, and a payment due date.

37. The system of claim 31, the processor further configured to generate a second display screen including additional information regarding the alert message associated with the payment entry that is associated with the at least one client includes the conflict.

38. The system of claim 37, wherein the second display screen is generated in response to a user request for reviewing the alert message.

39. The system of claim 38, wherein the memory stores an application programming interface (API), and the processor receives the user request for reviewing the alert message via an API function call.

40. The system of claim 39, wherein the API function call includes a public key, and a private key associated with the user used to digitally sign the API function call, the processor further configured to determine, based at least in part on the digital signature of the API function call, the identity of the user.
